(19) United States
(12) Patent Application Publication
(10) Pub. No.: US 2007/0190498 A1
(43) Pub. Date: Aug. 16, 2007

(54) Device to teach the proper use of common hand tools

(76) Inventors: Hal Dwayne Lilley, North East, PA (US); Victoria Orn Lilley, North East, PA (US)

Correspondence Address: Hal D. Lilley, 8323 Ox Bow Road, North East, PA, 16428, US

(21) Appl. No.: 11/699,864

(22) Filed: Jan. 30, 2007

Related U.S. Application Data
(60) Provisional application No. 60/763,769, filed on Feb. 1, 2006.

(51) Int. Cl. G09B 11/00

(52) U.S. Cl. 434/81

(57) ABSTRACT

The device to teach the proper use of common hand tools provides an area where individuals at any age can repeatedly use and learn the proper use of common hand tools, and to use these common hand tools with the corresponding machine screws that are in common use. It is a rectangular shaped base with a durable insert. The durable insert contains several threaded holes, labeled with a specific type of machine screw. The label directs the individual where to insert each machine screw. The individual then turns the screw in the proper direction into the threaded hole with the corresponding common hand tool, until it is gently tightened. The individual then returns the common hand tool to its proper storage compartment upon the completion of the task.

### BACKGROUND OF THE INVENTION

In the 21st century, most people rely on others to do basic jobs, such as auto repairs, home maintenance, etc. Therefore, many people have lost their skills and knowledge of using basic common hand tools. This loss has been recognized by academia and the US government. After recognizing that children are no longer being taught how to use common hand tools to fulfill their basic future needs as home owners and automobile owners, the government has put in place, in the No Child Left Behind Act, a set of standards that requires school-age children to be taught the basic knowledge of common hand tools, and how they are to be used. The present invention fulfills that need. It provides a work area, a learning station, so that children can associate common hand tools and how they are to be used. The learning station also provides the association of common hand tools with their corresponding machine screws and how they are to be used. Although at present children are not being taught at a young age how to use common hand tools, the reality is everyone needs to know how to use common hand tools, whether it be a mechanic working on your car, a home repairman working on your washer, dryer, refrigerator, furnace, etc, a dentist using specialized screw drivers to tighten braces, or an orthopedic surgeon inserting screws to hold a broken leg together. The purpose of this invention is to teach, at an early age, the proper use of common hand tools, and how they relate to their corresponding machine screws.

### BRIEF SUMMARY OF THE INVENTION

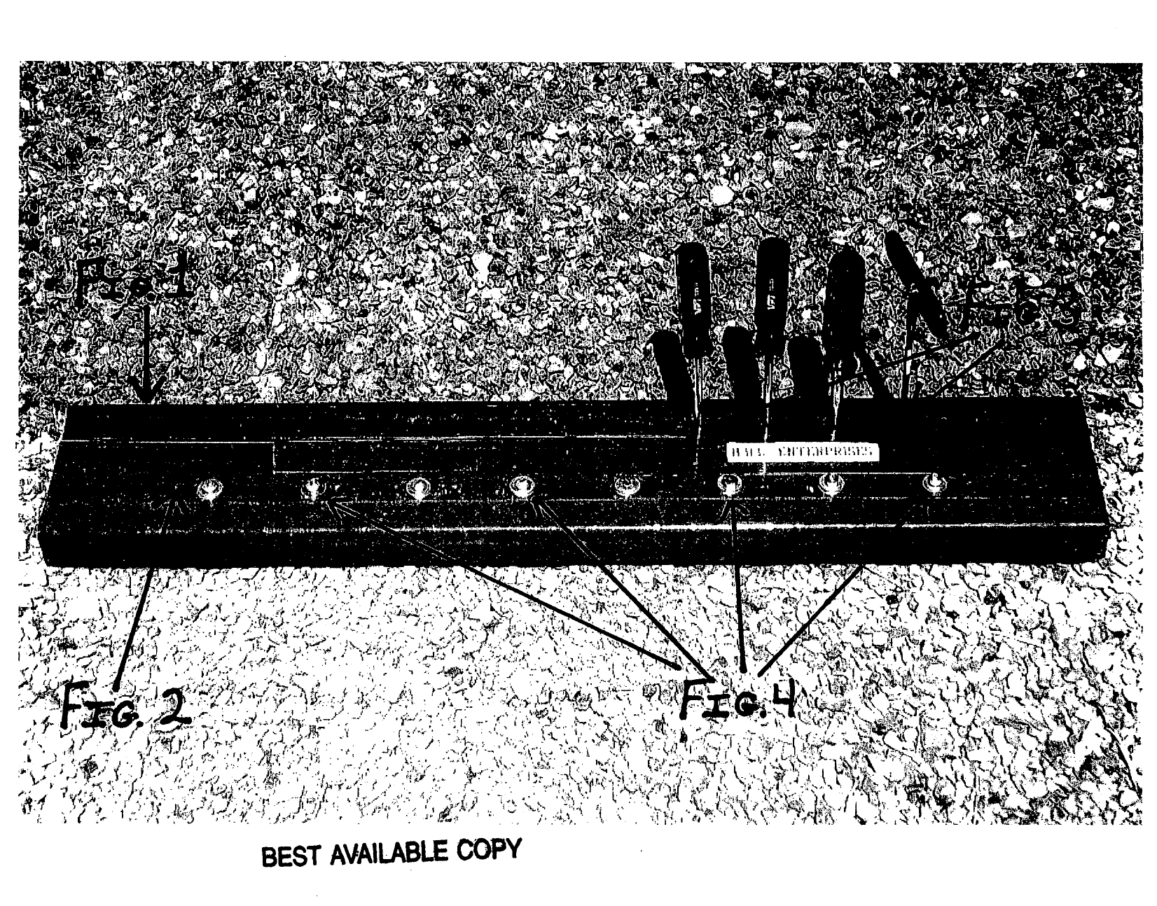

FIG. 1. A rectangular shape with a sufficient thickness to contain a depression which will house a durable material insert.

FIG. 2. A durable material insert that has sufficient thickness to accommodate multiple threaded holes that will accept machine screws.

FIG. 3. Multiple perforations for the housing of common hand tools, of sufficient depth to hold the common hand tools in an upright position.

FIG. 4. Threaded holes labeled to direct the placement of different types of machine screws, using the corresponding common hand tool to manipulate and gently tighten.

### DETAILED DESCRIPTION OF THE INVENTION

The purpose of the invention is to provide a device with a durable threaded insert so it can be used repeatedly by individuals of any age to practice and learn the use of common hand tools to turn in the proper direction the corresponding machine screws.

The invention is comprised of a rectangular base, with a durable material insert. The durable material insert has perforations that have been drilled and tapped to accommodate machine screws. The durable material insert contains several threaded holes, labeled for a specific type of machine screw. The label directs the individual where to insert each machine screw. The individual inserts the machine screw with the corresponding common hand tool and gently tightens. When all of the machine screws have been inserted into the properly labeled threaded holes with the corresponding common hand tools, the individual then returns the common hand tool to its proper storage compartment. Examples of common hand tools used with this device would be a straight slot screwdriver, a phillips head screwdriver, a hex head screwdriver, and an allen head wrench. Unlike prior art, which has been reviewed, the present invention does not rehabilitate or evaluate. Unlike prior art, it is not a manipulative aptitude test nor a dexterity test. Unlike prior art, the present invention does not use large plastic pieces to fit into small holes, as a toddler's toy. Prior art shows the teaching of different types of door locks, used for developing manual dexterity. The present invention is not intended to test the capability of individuals for future employment. The present invention teaches how to use and identify common hand tools for everyday tasks. There are thousands of hand tools in different forms, shapes, and varieties used every day. Many of these are very specialized for the automotive industry, for the medical profession, for the dental profession. There are also many different kinds of power tools. But the use and the learning of common hand tools, and identifying them with the corresponding machine screws that they are to be used with is the basis of this invention.

### REFERENCES CITED

| | |
|---|---|
| 2835986 | Roeder |
| 3276149 | Barnabas |
| 3427731 | Debolt |
| 4457722 | Housand |
| 4795351 | Vermette |
| 6142786 | Culberson et al. |

1. A rectangular shaped device to aid in teaching the proper use of common hand tools, the base being of substantial size and shape as it can be used with machine screws and common hand tools and remain stationary.

2. A durable material insert that is fitted into said base, having a plurality of holes that are threaded to accept common machine screws. Said threaded holes are labeled with the specific type of machine screw that is to be inserted into each threaded hole, teaching the use of several different common hand tools corresponding with the proper machine screw.

3. The base also having a plurality of holes in which the common hand tools can be inserted in an upright position, teaching good house keeping by returning said tools to said holes upon the completion of a task.
